(19) United States
(12) Patent Application Publication
(10) Pub. No.: US 2023/0061599 A1
(43) Pub. Date: Mar. 2, 2023

(54) POSITIONING METHOD, ELECTRONIC DEVICE AND STORAGE MEDIUM

(71) Applicant: BEIJING BAIDU NETCOM SCIENCE TECHNOLOGY CO., LTD., Beijing (CN)

(72) Inventors: Lei XIA, Beijing (CN); Hailu Jia, Beijing (CN); Xi Chen, Beijing (CN); Guangdi Shan, Beijing (CN)

(73) Assignee: BEIJING BAIDU NETCOM SCIENCE TECHNOLOGY CO., LTD., Beijing (CN)

(21) Appl. No.: 17/983,835

(22) Filed: Nov. 9, 2022

(30) Foreign Application Priority Data
Nov. 10, 2021 (CN) 202111329616.X

(51) Int. Cl. G01S 19/27; G01S 19/29

(52) U.S. Cl. CPC G01S 19/27; G01S 19/29

(57) ABSTRACT

A positioning method, an electronic device and a storage medium, which relate to a field of computer technology, and in particular to fields of positioning technology and satellite navigation technology. The method includes: acquiring satellite observation data for a target object, broadcast ephemeris data for the target object, and state space representation for the target object; performing an error correction on the broadcast ephemeris data using the state space representation; determining a target positioning model according to the satellite observation data and the corrected broadcast ephemeris data; and performing a resolving operation on the target positioning model to obtain position data of the target object.

This application claims priority to Chinese Patent Application No. 202111329616.X, filed on Nov. 10, 2021, which is incorporated herein in its entirety by reference.

### TECHNICAL FIELD

The present disclosure relates to a field of computer technology, and in particular to fields of positioning technology and satellite navigation technology. More specifically, the present disclosure relates to a positioning method, an electronic device and a storage medium.

### BACKGROUND

With a growing demand for a position service, the public has higher and higher requirements for positioning accuracy. A smartphone has become an indispensable tool in people's lives. Due to a limitation of a hardware condition, a low-cost linearly polarized antenna and a low-cost, low-power navigation chip which are integrated in the smartphone lead to a low positioning accuracy of the smartphone.

### SUMMARY

The present disclosure provides a positioning method, an electronic device, and a storage medium.

According to an aspect of the present disclosure, a positioning method is provided, including: acquiring satellite observation data for a target object, broadcast ephemeris data for the target object, and state space representation for the target object; performing an error correction on the broadcast ephemeris data using the state space representation; determining a target positioning model according to the satellite observation data and the corrected broadcast ephemeris data; and performing a resolving operation on the target positioning model to obtain position data of the target object.

According to another aspect of the present disclosure, an electronic device is provided, including: at least one processor; and a memory communicatively connected to the at least one processor, wherein the memory stores instructions executable by the at least one processor, and the instructions, when executed by the at least one processor, cause the at least one processor to implement the method according to embodiments of the present disclosure.

According to another aspect of the present disclosure, a non-transitory computer-readable storage medium having computer instructions therein is provided, wherein the computer instructions are configured to cause a computer system to implement the method according to embodiments of the present disclosure.

It should be understood that content described in this section is not intended to identify key or important features in embodiments of the present disclosure, nor is it intended to limit the scope of the present disclosure. Other features of the present disclosure will be easily understood through the following description.

### BRIEF DESCRIPTION OF THE DRAWINGS

The accompanying drawings are used to understand the present disclosure better and do not constitute a limitation to the present disclosure, wherein:

FIG. 1A shows a schematic diagram of an application scenario of a positioning method, a positioning apparatus, an electronic device, and a storage medium according to an embodiment of the present disclosure;

FIG. 1B schematically shows a schematic diagram of a positioning method according to an embodiment of the present disclosure;

FIG. 2 schematically shows a flowchart of a positioning method according to an embodiment of the present disclosure;

FIG. 3 schematically shows a flowchart of a method of performing error correction on broadcast ephemeris data according to an embodiment of the present disclosure;

FIG. 4 schematically shows a flowchart of a method of determining a target positioning model according to an embodiment of the present disclosure;

FIG. 5 schematically shows a flowchart of a method of determining a target positioning model according to an embodiment of the present disclosure;

FIG. 6 schematically shows a schematic diagram of a positioning method according to another embodiment of the present disclosure;

FIG. 7 schematically shows a block diagram of a positioning apparatus according to an embodiment of the present disclosure; and

FIG. 8 schematically shows a block diagram of an example electronic device for implementing an embodiment of the present disclosure.

### DETAILED DESCRIPTION OF EMBODIMENTS

Exemplary embodiments of the present disclosure will be described below with reference to the accompanying drawings, which include various details of embodiments of the present disclosure to facilitate understanding and should be considered as merely exemplary. Therefore, those of ordinary skilled in the art should realize that various changes and modifications may be made to embodiments described herein without departing from the scope and spirit of the present disclosure. Likewise, for clarity and conciseness, descriptions of well-known functions and structures are omitted in the following description.

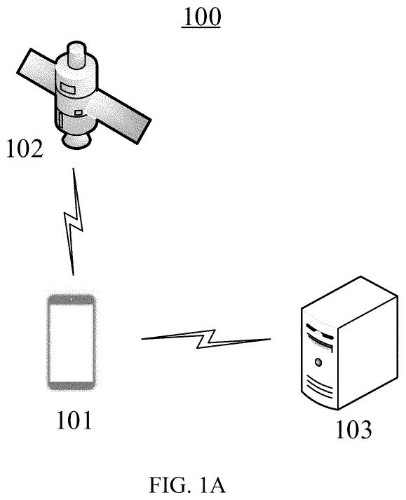

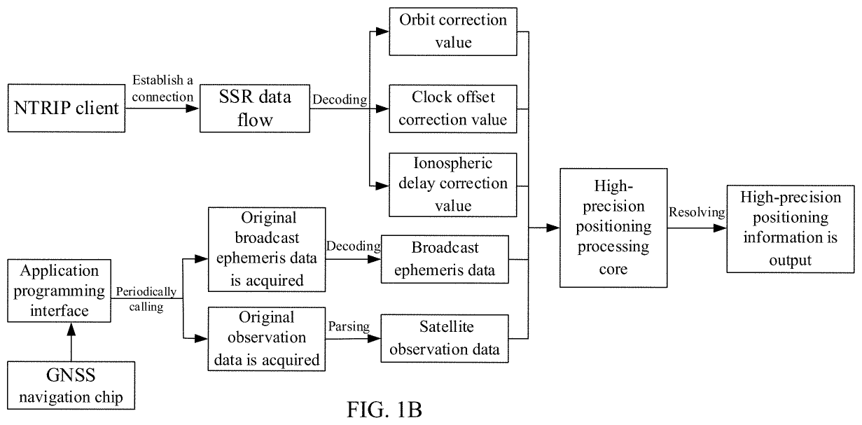

An application scenario of a positioning method and a positioning apparatus provided by the present disclosure will be described below with reference to FIG. 1A.

FIG. 1A shows a schematic diagram of an application scenario of a positioning method, a positioning apparatus, an electronic device and a storage medium according to an embodiment of the present disclosure. It should be noted that FIG. 1A is only an example application scenario to which embodiments of the present disclosure may be applied, so as to help those skilled in the art to understand the technical content of the present disclosure. However, it does not mean that embodiments of the present disclosure cannot be applied to other devices, systems, environment or scenarios.

As shown in FIG. 1A, an application scenario 100 may include a terminal device 101, a satellite navigation system 102, and a server 103. A network is a medium used to provide a communication link between the terminal device 101 and the server 103. The network may include various connection types, such as a wired communication link, a wireless communication link, or a fiber optic cable, etc.

The terminal device 101 may be used by a user to interact with the server 103 through the network to receive or send a message. Various communication client applications, such as a map navigation application, a shopping application, a web browser application, a search application, an instant messaging tool, an email client, a social platform software, etc. (only examples), may be installed on the terminal device 101.

The terminal device 101 may be various electronic devices having a Global Navigation Satellite System (GNSS) navigation chip and a processing core and supporting network communication, including but not limited to a smart phone, a tablet computer, a laptop computer and a desktop computer, etc.

The terminal device 101 may also be used to receive broadcast ephemeris data, and obtain orbit data and clock offset data of the satellite, etc. by parsing the broadcast ephemeris data.

The satellite navigation system 102 may be used to provide a navigation service, and may include, for example, a Beidou satellite navigation system, a Global Positioning System (GPS), a GLONASS satellite navigation system, a Galileo satellite positioning system, etc.

The terminal device 101 may communicate with a satellite in the satellite navigation system 102 to acquire data such as a pseudo-range, a signal-to-noise ratio, a carrier phase, a Doppler observation value, and an Accumulated Delta Range State (ADRS).

The server 103 may be a server that provides a Real-time Service (RTS), such as a server set up by the International GNSS Service (IGS) or other institutions and used to provide real-time state space representation.

The terminal device 101 may acquire the real-time State Space Representation (SSR) from the server 103 by using Networked Transport of RTCM via Internet Protocol (NTRIP).

Based on the above-mentioned application scenario, FIG. 1B schematically shows a schematic diagram of a positioning method according to an embodiment of the present disclosure.

As shown in FIG. 1B, according to an embodiment of the present disclosure, the terminal device 101 may establish an NTRIP-based connection with the server 103 through an NTRIP client, and then acquire SSR data flow from the server 103 using the connection. Then, an orbit correction value, a clock offset correction value and an ionospheric delay correction value may be obtained by decrypting the SSR data flow.

In an aspect, the terminal device 101 may periodically call an Application Programming Interface (API) for acquiring GNSS data to acquire original broadcast ephemeris data and original observation data observed by the GNSS navigation chip, where a calling time interval may be set as desired in practice. For example, in this embodiment, the terminal device 101 may call once per second. Then, the original broadcast ephemeris data may be decoded to obtain the broadcast ephemeris data. The original observation data may be parsed to obtain the satellite observation data. In an example, in this embodiment, the original broadcast ephemeris data may be binary navigation data in a RTCM format. The RTCM format is defined by a GNSS differential signal format proposed by the Radio Technical Commission for Maritime services (RTCM).

According to an embodiment of the present disclosure, after obtaining the orbit correction value, the clock offset correction value, the ionospheric delay correction value, the broadcast ephemeris data and the satellite observation data, it is possible to perform, by using the high-precision positioning processing core of the terminal device 101, a high-precision positioning resolving so as to output high-precision positioning information.

In a technical solution of the present disclosure, the collection, storage, use, processing, transmission, provision and disclosure of the satellite observation data, the broadcast ephemeris data, the state space representation and the position data involved comply with relevant laws and regulations, and do not violate public order and good customs.

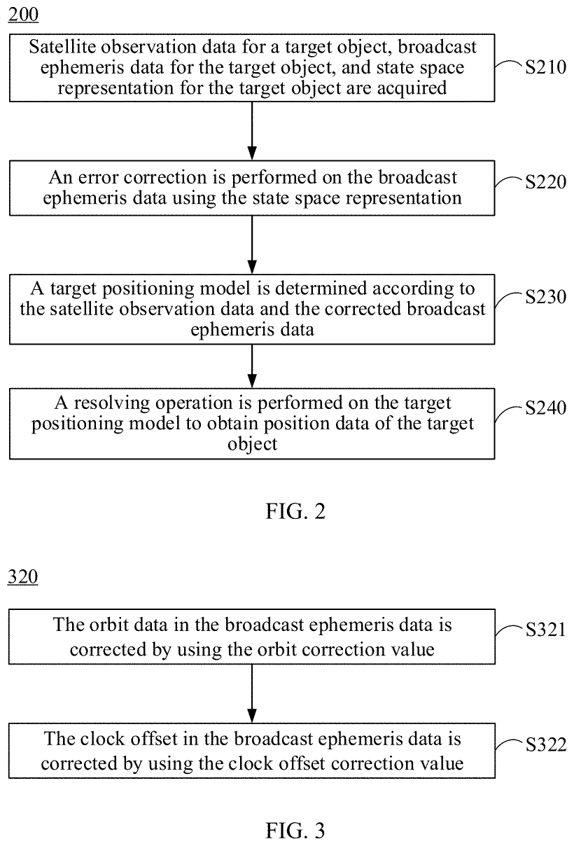

FIG. 2 schematically shows a flowchart of a positioning method according to an embodiment of the present disclosure.

As shown in FIG. 2, a positioning method 200 may include operations S210 to S240. For example, the method 200 may be implemented by the terminal device described above.

In operation S210, satellite observation data for a target object, broadcast ephemeris data for the target object, and state space representation for the target object are acquired.

In operation S220, an error correction is performed on the broadcast ephemeris data using the state space representation.

In operation S230, a target positioning model is determined according to the satellite observation data and the corrected broadcast ephemeris data.

In operation S240, a resolving operation is performed on the target positioning model to obtain position data of the target object.

According to an embodiment of the present disclosure, the satellite orbit, a clock offset, the ionospheric delay and the like in the broadcast ephemeris data are corrected by using the state space representation broadcast in real-time. Positioning according to the corrected broadcast ephemeris data may improve the positioning accuracy.

According to an embodiment of the present disclosure, the target object may include, for example, the terminal device described above.

According to an embodiment of the present disclosure, the satellite observation data may include, for example, a signal-to-noise ratio, pseudo-ranges at a plurality of epochs, Doppler observation values at the plurality of epochs and the like. The broadcast ephemeris data may include, for example, orbit data, the clock offset and the like.

According to an embodiment of the present disclosure, for example, the satellite observation data and the broadcast ephemeris data are acquired by calling a navigation satellite observation data acquisition interface of an operating system. The operating system may include, for example, the Android system. The navigation satellite observation data acquisition interface may include, for example, an application programming interface for acquiring a GNSS observation value.

According to an embodiment of the present disclosure, after obtaining the satellite observation data, it is possible to pre-process the satellite observation data to eliminate abnormal data, that is, a gross error. Based on this, the pseudo-ranges at the plurality of epochs may be differenced to determine pseudo-range detection values, and in response to a pseudo-range detection value in the pseudo-range detection values exceeding a first threshold value, a pseudo-range corresponding to the pseudo-range detection value may be deleted from the pseudo-ranges at the plurality of epochs. In addition, the Doppler observation values at the plurality of epochs may be differenced to determine Doppler detection values, and in response to a Doppler detection value in the Doppler detection values exceeding a second threshold value, a Doppler observation value corresponding to the Doppler detection value may be deleted from the Doppler observation values at the plurality of epochs.

According to another embodiment of the present disclosure, it is also possible to smooth the Doppler observation values to obtain a pseudo-range reference value. Then the pseudo-ranges are corrected according to the pseudo-range reference value. As the accuracy of the Doppler observation value is much greater than that of the pseudo-range, the accuracy of the pseudo-range may be improved by constructing a new pseudo-range in a Doppler smoothing manner.

According to another some embodiments of the present disclosure, in addition to the signal-to-noise ratio, the pseudo-ranges at the plurality of epochs, and the Doppler observation values at the plurality of epochs, the satellite observation data further includes a carrier phase. Based on this, it may be determined whether the carrier phase is abnormal or not by at least one selected from: an accumulated delta range state method, a Doppler cycle-slip detection method, an ionospheric residual method, or a higher-order difference method. And then, an abnormal carrier phase is deleted.

The carrier phase is a key to achieve high-precision positioning, and it is very important to determine whether the carrier phase is abnormal or not. However, due to the poor antenna and low power consumption of the chip in the terminal device, the carrier phase is very prone to abnormality. According to an embodiment of the present disclosure, the positioning accuracy may be improved by adopting the above-mentioned various methods to determine whether the carrier phase is abnormal or not. In addition, the positioning method of embodiments of the present disclosure may reduce a dependence on a base station, and may reduce the cost.

According to an embodiment of the present disclosure, the state space representation may include, for example, the orbit correction value and the clock offset correction value.

According to an embodiment of the present disclosure, for example, it is possible to establish a connection with the server in advance. Then the state space representation may be acquired through the connection with the server. In an example, the state space representation may be in the RTCM format. Correspondingly, a connection with the server may be established based on the NTRIP protocol, and the state space representation in the RTCM format may be acquired through the connection.

According to an embodiment of the present disclosure, after the state space representation is obtained, it is also possible to perform data processing on the state space representation to satisfy the needs of a subsequent operation. For example, the orbit data in the state space representation provides satellite tangential, normal and radial correction values. The orbit data may be converted into a geocentric coordinate system to facilitate correction of a satellite position calculated in the broadcast ephemeris. In addition, as the state space representation provided by the server is updated at a certain frequency, the acquired orbit correction value and clock offset correction value may not correspond to a current time instant. Based on this, an orbit correction value and a clock offset correction value at the current time instant may be extrapolated according to the acquired orbit correction value and clock offset correction value. In addition, it is possible to match the state space representation and the broadcast ephemeris data by using an issue of data ephemeris, and select a state space representation matched with the broadcast ephemeris data.

According to an embodiment of the present disclosure, the state space representation may be used to perform the error correction on the broadcast ephemeris data. A method of performing the error correction on the broadcast ephemeris data by using the state space representation is described below with reference to FIG. 3.

FIG. 3 schematically shows a flowchart of a method of performing error correction on broadcast ephemeris data according to an embodiment of the present disclosure.

As shown in FIG. 3, a method 320 of performing error correction on the broadcast ephemeris data may include operations S321 to S322.

In operation S321, the orbit data in the broadcast ephemeris data is corrected by using the orbit correction value.

In operation S322, the clock offset in the broadcast ephemeris data is corrected by using the clock offset correction value.

According to some embodiments of the present disclosure, in addition to the orbit correction value and the clock offset correction value, the state space representation may further include an ionospheric spherical harmonic model. In addition to the orbit data and the clock offset, the broadcast ephemeris data further includes an ionospheric delay.

The method of performing the error correction on the broadcast ephemeris data by using the state space representation may further include: calculating an ionospheric delay reference value by using the ionospheric spherical harmonic model; and correcting the ionospheric delay by using the ionospheric delay reference value.

According to an embodiment of the present disclosure, after correcting the broadcast ephemeris data, it is possible to determine the target positioning model according to the satellite observation data and the corrected broadcast ephemeris data.

According to an embodiment of the present disclosure, the satellite observation data may include observation data of at least one frequency band, that is, the satellite observation data may correspond to a single frequency band or a plurality of frequency bands. A method of determining the target positioning model in a case that the satellite observation data corresponds to the single frequency band is different from a method of determining the target positioning model in a case that the satellite observation data corresponds to the plurality of frequency bands.

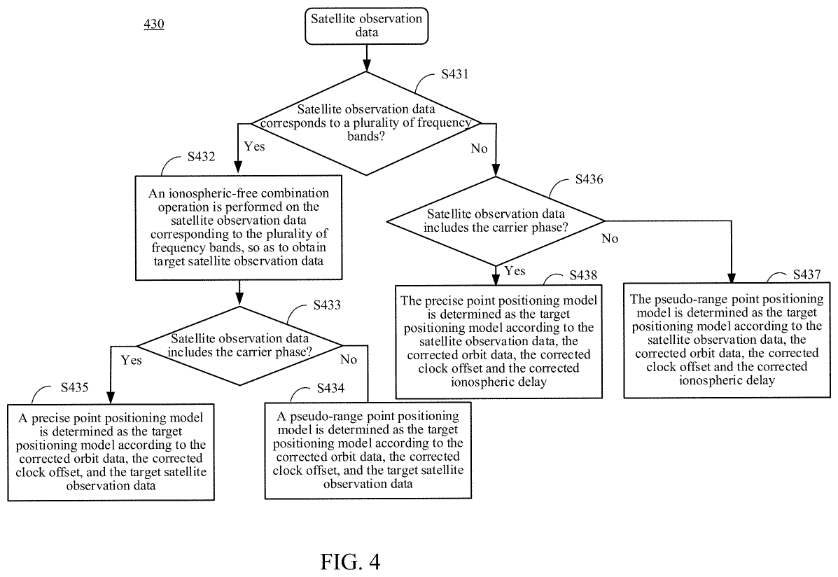

Based on this, a method of determining the target positioning model will be described below with reference to FIG. 4.

FIG. 4 schematically shows a flowchart of a method of determining the target positioning model according to an embodiment of the present disclosure.

As shown in FIG. 4, a method 430 of determining the target positioning model may include the following operations.

In operation S431, it may be determined whether the satellite observation data corresponds to a plurality of frequency bands or not. If the satellite observation data corresponds to a plurality of frequency bands, executing operation S432. If the satellite observation data corresponds to a single frequency band, executing operation S436.

In operation S432, an ionospheric-free combination operation is performed on the satellite observation data corresponding to the plurality of frequency bands, so as to obtain target satellite observation data.

In operation S433, it may be determined whether the satellite observation data includes the carrier phase or not. If the satellite observation data does not include the carrier phase, executing operation S434. If the satellite observation data includes the carrier phase, executing operation S435.

In operation S434, a pseudo-range point positioning model (Single-Point Positioning, SPP) is determined as the target positioning model according to the corrected orbit data, the corrected clock offset, and the target satellite observation data.

In operation S435, a precise point positioning model (PPP) is determined as the target positioning model according to the corrected orbit data, the corrected clock offset, and the target satellite observation data.

In operation S436, it may be determined whether the satellite observation data includes the carrier phase or not. If the satellite observation data does not include the carrier phase, executing operation S437. If the satellite observation data includes the carrier phase, executing operation S438.

In operation S437, the pseudo-range point positioning model is determined as the target positioning model according to the satellite observation data, the corrected orbit data, the corrected clock offset and the corrected ionospheric delay.

In operation S438, the precise point positioning model is determined as the target positioning model according to the satellite observation data, the corrected orbit data, the corrected clock offset and the corrected ionospheric delay.

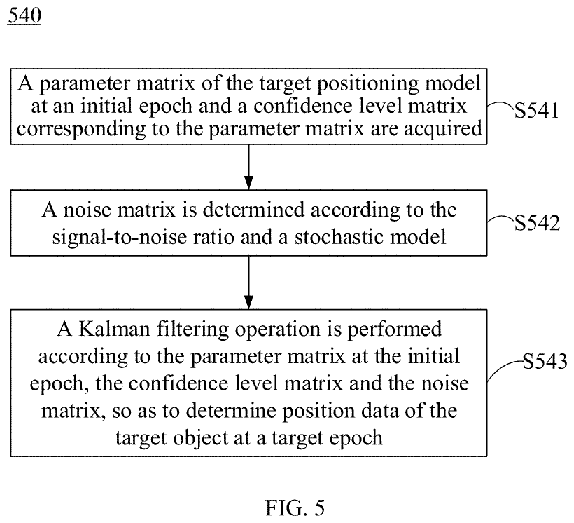

The method of determining the target positioning model will be described below with reference to FIG. 5.

FIG. 5 schematically shows a flowchart of a method of determining the target positioning model according to an embodiment of the present disclosure.

As shown in FIG. 5, a method 540 of determining the target positioning model may include the following operations.

In operation S541, a parameter matrix of the target positioning model at an initial epoch and a confidence level matrix corresponding to the parameter matrix are acquired.

In operation S542, a noise matrix is determined according to the signal-to-noise ratio and a stochastic model.

In operation S543, a Kalman filtering operation is performed according to the parameter matrix at the initial epoch, the confidence level matrix and the noise matrix, so as to determine position data of the target object at a target epoch.

According to an embodiment of the present disclosure, parameters of the target positioning model may be set as required. For example, in this embodiment, parameters of the pseudo-range point positioning model may include, for example, a three-dimensional position, the clock offset, and a speed, etc. The parameters of the precise point positioning model may include, for example, the three-dimensional position, the clock offset, a tropospheric delay, and a hardware delay, etc. The three-dimensional position may be calculated according to the pseudo-range. The speed may be calculated from the Doppler observation value.

According to an embodiment of the present disclosure, the relationship between the signal-to-noise ratio and a pseudo-range noise may be calibrated to construct a signal-to-noise ratio model through prior quality analysis. The signal-to-noise ratio model may be used to weight observation values of different satellite systems and data frequency bands.

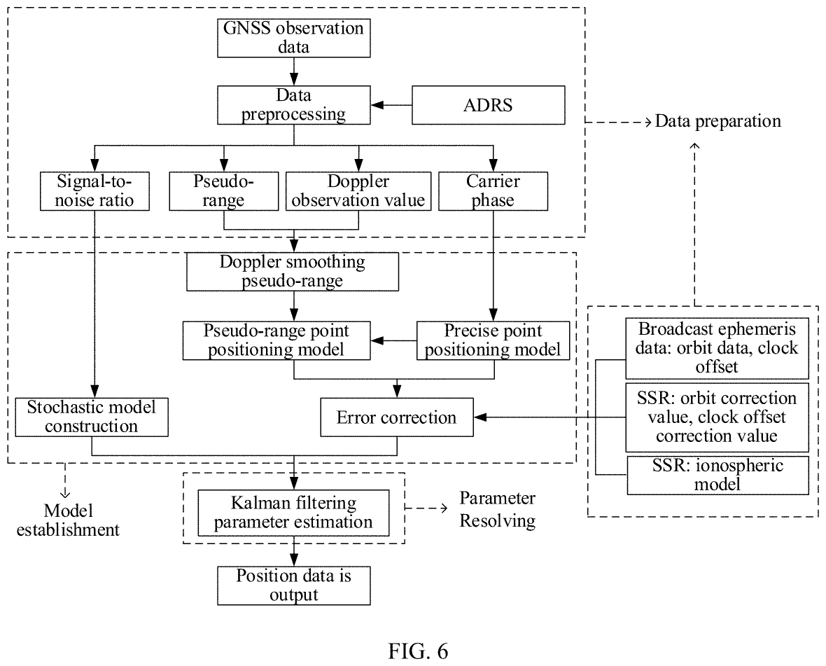

The positioning method described above will be further described below with reference to FIG. 6 in conjunction with specific embodiments. Those skilled in the art may understand that the following exemplary embodiments are only for understanding the present disclosure, and the present disclosure is not limited thereto.

FIG. 6 schematically shows a schematic diagram of a positioning method according to an embodiment of the present disclosure.

As shown in FIG. 6, according to an embodiment of the present disclosure, it is possible to acquire GNSS data through an application programming interface for acquiring GNSS observation value. The GNSS data includes the pseudo-range, the signal-to-noise ratio, the carrier phase, the Doppler observation value, the ADRS and original ephemeris data.

According to an embodiment of the present disclosure, RTS data may be acquired from a server of International GNSS Service or other institutions. The RTS data includes the orbit data of the satellite and the clock offset data, as well as the ionospheric spherical harmonic model data.

After decoding GNSS original data and the RTS data, a further processing is required. Therefore, in a data preparation stage, the pseudo-range, the Doppler observation value and a carrier phase observation value may be preprocessed to eliminate abnormal data. For the pseudo-range and the Doppler observation value, detection values may be obtained by differencing pseudo-ranges and Doppler observation values at epochs, and an appropriate threshold value may be set to determine whether the pseudo-range and the Doppler observation value is abnormal or not, and then abnormal data may be eliminated. For the carrier phase, it may be determined whether the carrier phase is abnormal or not by at least one selected from: ADRS marking, a Doppler cycle-slip detection method, an ionospheric residual method, or a higher-order difference method, and then abnormal data may be eliminated.

In addition, for the orbit data, the satellite tangential, normal and radial correction values contained in the orbit data may be converted to the geodetic coordinate system. The orbit data and the clock offset data are extrapolated to the current time instant. It is possible to match the RTS data and the ephemeris data by using the issue of data ephemeris (IODE), and then unmatched data may be eliminated. The issue of data ephemeris may be, for example, IODE in the GPS system. The IODE refers to an ephemeris data event, and its value represents the issue of data ephemeris. The value of IODE does not repeat within 6 hours.

Hardware of different terminal devices are quite different from each other. GNSS observation data obtained by different chips and antennas are different. For example, different terminal devices have different satellite frequency bands, carrier availabilities and data qualities. Therefore, different positioning models need to be constructed for different terminal devices.

Based on this, in a stage of constructing a model, in a case that the satellite observation data include observation values corresponding to a plurality of frequency bands, the ionospheric-free combination operation may be performed on the observation values corresponding to the plurality of frequency bands, so as to obtain a target observation value. In a case that the satellite observation data only include an observation value corresponding to a single frequency band, the ionospheric delay is calculated by using the ionospheric spherical harmonic model, then the ionospheric delay is subtracted from the original observation value to obtain a target observation value.

In this embodiment, not every terminal device may acquire the carrier phase.

Based on this, in a case that the satellite observation data include a carrier phase observation value, the precise point positioning model may be selected to use. In a case that the satellite observation data does not include the carrier phase observation value, the pseudo-range point positioning model may be selected to use.

The data quality is mainly reflected in a level of the pseudo-range noise. Different terminal devices are quite different. Even for the same terminal device, good and bad data qualities exist at the same time. Therefore, the noise may be processed by stochastic model construction and a Doppler smoothed pseudo-range. For example, the relationship between the signal-to-noise ratio and the pseudo-range noise may be calibrated to construct the signal-to-noise ratio model through the prior quality analysis, so as to weight the observation values of different satellite systems and data frequency bands. In addition, a new pseudo-range may be obtained by smoothing the Doppler observation values. As the Doppler observation value is much more accurate than the pseudo-range, the accuracy may be improved by constructing the new pseudo-range in the smoothing manner.

Next, in a stage of resolving a parameter, parameters of the pseudo-range point positioning model may include the three-dimensional position (X, Y, Z), as well as a clock offset and a carrier speed of the terminal device. In this embodiment, one clock offset may be set for each satellite system. The carrier speed may be obtained from the least squares calculation of the Doppler observation value.

Parameters of the precise point positioning model may include the three-dimensional position (X, Y, Z), a mobile phone clock offset, the tropospheric delay, and the hardware delay, etc.

In an example, the following takes the pseudo-range point positioning model as an example to illustrate a parameter resolving process.

In this embodiment, at an initial epoch (t), parameters such as the three-dimensional position (x(t), y(t), z(t)) and the clock offset (dtr(t)) are calculated using the pseudo-range point positioning model. Current speeds vx(t), vy(t), and vz(t) are calculated by using the Doppler observation value, while a confidence level matrix P(t) corresponding to the position, the clock offset and the speed may also be obtained. The parameters such as the three-dimensional position and the clock offset, etc., at the time instant t may be output as a result of the time instant t. A confidence level matrix at an initial time instant may be set according to experience.

At a time instant t+1, a Kalman filtering is performed. For example, parameters and confidence levels at the time instant t+1 are predicted: the position and the speed at epoch t are used to predict a position at the current time instant (such as x(t+1)=x(t)+v(t)*(t+1−t)). Other parameters at the time instant t+1, such as the clock offset, is directly equal to the clock offset at the time instant t. A confidence level of a parameter such as the position at the time instant t+1=the confidence level at the time instant t+(plus) a noise of the prediction process.

Then, a prediction residual is calculated. For example, the position at the time instant t+1 and the satellite position in the broadcast ephemeris are used to predict a distance between the satellite and the terminal device, that is, a pseudo-range P1, and a pseudo-range observation value P2 of the terminal device at the time instant t+1 may be acquired. A difference between P1 and P2 is the residual v=P1-P2.

Next, the noise is calculated. For example, the currently observed noise matrix may be obtained by using the stochastic model, that is, the signal-to-noise ratio may be input into the stochastic model to output the noise.

Next, a gain matrix K is calculated by using the confidence level matrix of the predicted values of the parameters and the noise of the residual, where K is a matrix that balances the predicted value and the current observation value. Parameters such as a current filtered three-dimensional position and the confidence level matrix of the parameters are calculated. The Doppler observation value at the time instant t+1 is used to calculate the speed at the time instant t+1.

Similarly, at the time instant t+2, the above Kalman filtering operation is performed by using parameters such as the three-dimensional position, the confidence level and the speed at the time instant t+1 until parameters such as the three-dimensional position of terminal device at each epoch are calculated, so as to achieve high-precision positioning of the terminal device.

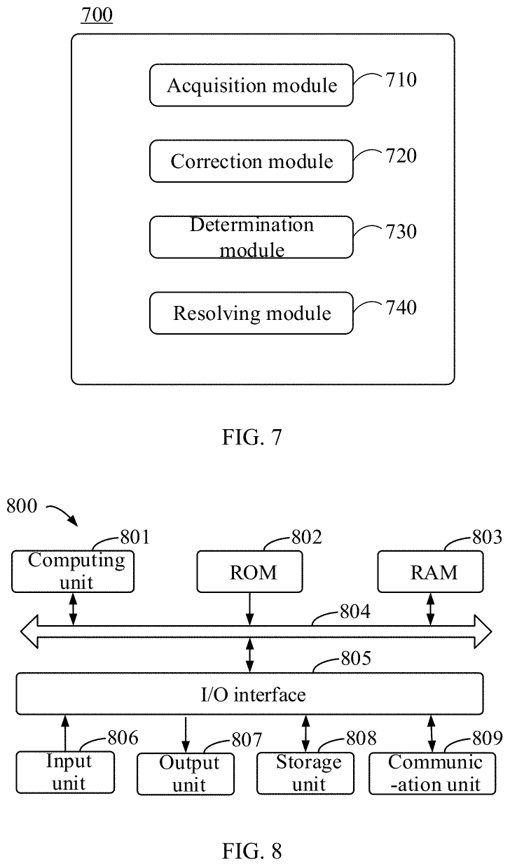

A positioning apparatus according to embodiments of the present disclosure will be described below with reference to FIG. 7.

FIG. 7 schematically shows a block diagram of a positioning apparatus according to an embodiment of the present disclosure.

As shown in FIG. 7, a positioning apparatus 700 includes an acquisition module 710, a correction module 720, a determination module 730 and a resolving module 740.

The acquisition module 710 is used to acquire satellite observation data for a target object, broadcast ephemeris data for the target object, and state space representation for the target object.

The correction module 720 is used to perform an error correction on the broadcast ephemeris data using the state space representation.

The determination module 730 is used to determine a target positioning model according to the satellite observation data and the corrected broadcast ephemeris data.

The resolving module 740 is used to perform a resolving operation on the target positioning model to obtain position data of the target object.

According to embodiments of the present disclosure, the present disclosure further provides an electronic device, a readable storage medium and a computer program product.

FIG. 8 shows a schematic block diagram of an exemplary electronic device 800 for implementing embodiments of the present disclosure. The electronic device is intended to represent various forms of digital computers, such as a laptop computer, a desktop computer, a workstation, a personal digital assistant, a server, a blade server, a mainframe computer, and other suitable computers. The electronic device may further represent various forms of mobile devices, such as a personal digital assistant, a cellular phone, a smart phone, a wearable device, and other similar computing devices. The components as illustrated herein, and connections, relationships, and functions thereof are merely examples, and are not intended to limit the implementation of the present disclosure described and/or required herein.

As shown in FIG. 8, the device 800 may include a computing unit 801, which may perform various appropriate actions and processing based on a computer program stored in a read-only memory (ROM) 802 or a computer program loaded from a storage unit 808 into a random access memory (RAM) 803. Various programs and data required for the operation of the device 800 may be stored in the RAM 803. The computing unit 801, the ROM 802 and the RAM 803 are connected to each other through a bus 804. An input/output (I/O) interface 805 is further connected to the bus 804.

Various components in the device 800, including an input unit 806 such as a keyboard, a mouse, etc., an output unit 807 such as various types of displays, speakers, etc., a storage unit 808 such as a magnetic disk, an optical disk, etc., and a communication unit 809 such as a network card, a modem, a wireless communication transceiver, etc., are connected to the I/O interface 805. The communication unit 809 allows the device 800 to exchange information/data with other devices through a computer network such as the Internet and/or various telecommunication networks.

The computing unit 801 may be various general-purpose and/or special-purpose processing components with processing and computing capabilities. Some examples of the computing unit 801 include but are not limited to a central processing unit (CPU), a graphics processing unit (GPU), various dedicated artificial intelligence (Al) computing chips, various computing units running machine learning model algorithms, a digital signal processor (DSP), and any appropriate processor, controller, microcontroller, and so on. The computing unit 801 may perform the various methods and processes described above, such as the positioning method. For example, in some embodiments, the positioning method may be implemented as a computer software program that is tangibly contained on a machine-readable medium, such as the storage unit 808. In some embodiments, part or all of a computer program may be loaded and/or installed on the device 800 via the ROM 802 and/or the communication unit 809. When the computer program is loaded into the RAM 803 and executed by the computing unit 801, one or more steps of the positioning method described above may be performed. Alternatively, in other embodiments, the computing unit 801 may be used to perform the positioning method in any other appropriate way (for example, by means of firmware).

Various embodiments of the systems and technologies described herein may be implemented in a digital electronic circuit system, an integrated circuit system, a field programmable gate array (FPGA), an application specific integrated circuit (ASIC), an application specific standard product (ASSP), a system on chip (SOC), a complex programmable logic device (CPLD), a computer hardware, firmware, software, and/or combinations thereof. These various embodiments may be implemented by one or more computer programs executable and/or interpretable on a programmable system including at least one programmable processor. The programmable processor may be a special-purpose or general-purpose programmable processor, which may receive data and instructions from the storage system, the at least one input device and the at least one output device, and may transmit the data and instructions to the storage system, the at least one input device, and the at least one output device.

Program codes for implementing the method of the present disclosure may be written in one programming language or any combination of programming languages. These program codes may be provided to a processor or a controller of a general-purpose computer, a special-purpose computer, or other programmable data processing devices, so that when the program codes are executed by the processor or the controller, the functions/operations specified in the flowchart and/or block diagram may be implemented. The program codes may be executed completely on the machine, partly on the machine, partly on the machine and partly on the remote machine as an independent software package, or completely on the remote machine or the server.

In the context of the present disclosure, the machine readable medium may be a tangible medium that may contain or store programs for use by or in combination with an instruction execution system, device or apparatus. The machine readable medium may be a machine-readable signal medium or a machine-readable storage medium. The machine readable medium may include, but not be limited to, electronic, magnetic, optical, electromagnetic, and infrared or semiconductor systems, devices or apparatuses, or any suitable combination of the above. More specific examples of the machine readable storage medium may include electrical connections based on one or more wires, portable computer disks, hard disks, random access memory (RAM), read-only memory (ROM), erasable programmable read-only memory (EPROM or flash memory), optical fiber, convenient compact disk read-only memory (CD-ROM), optical storage device, magnetic storage device, or any suitable combination of the above.

In order to provide interaction with users, the systems and techniques described here may be implemented on a computer including a display device (for example, a CRT (cathode ray tube) or LCD (liquid crystal display) monitor) for displaying information to the user), and a keyboard and a pointing device (for example, a mouse or a trackball) through which the user may provide the input to the computer. Other types of devices may also be used to provide interaction with users. For example, a feedback provided to the user may be any form of sensory feedback (for example, visual feedback, auditory feedback, or tactile feedback), and the input from the user may be received in any form (including acoustic input, voice input or tactile input).

The systems and technologies described herein may be implemented in a computing system including back-end components (for example, a data server), or a computing system including middleware components (for example, an application server), or a computing system including front-end components (for example, a user computer having a graphical user interface or web browser through which the user may interact with the implementation of the system and technology described herein), or a computing system including any combination of such back-end components, middleware components or front-end components. The components of the system may be connected to each other by digital data communication (for example, a communication network) in any form or through any medium. Examples of the communication network include a local area network (LAN), a wide area network (WAN), and Internet.

A computer system may include a client and a server. The client and the server are generally far away from each other and usually interact through a communication network. The relationship between the client and the server is generated through computer programs running on the corresponding computers and having a client-server relationship with each other.

The server may be the cloud server, also referred to as the cloud computing server or the cloud host, which is the host product in the cloud computing service system to solve shortcomings of difficult management and weak business scalability in a conventional physical host and a VPS (Virtual Private Server) service. The server may also be a server of a distributed system, or a server combined with a block-chain.

It should be understood that steps of the processes illustrated above may be reordered, added or deleted in various manners. For example, the steps described in the present disclosure may be performed in parallel, sequentially, or in a different order, as long as a desired result of the technical solution of the present disclosure may be achieved. This is not limited in the present disclosure.

The above-mentioned specific embodiments do not constitute a limitation on the scope of protection of the present disclosure. Those skilled in the art should understand that various modifications, combinations, sub-combinations and substitutions may be made according to design requirements and other factors. Any modifications, equivalent replacements and improvements made within the spirit and principles of the present disclosure shall be contained in the scope of protection of the present disclosure.

What is claimed is:

1. A positioning method comprising:
acquiring satellite observation data for a target object, broadcast ephemeris data for the target object, and state space representation for the target object;
performing an error correction on the broadcast ephemeris data using the state space representation;
determining a target positioning model according to the satellite observation data and the corrected broadcast ephemeris data; and
performing a resolving operation on the target positioning model to obtain position data of the target object.

2. The method according to claim 1, wherein acquiring the satellite observation data and the broadcast ephemeris data comprises acquiring the satellite observation data and the broadcast ephemeris data by calling a navigation satellite data acquisition interface of an operating system.

3. The method according to claim 1, wherein acquiring the state space representation comprises acquiring the state space representation through a connection with a server.

4. The method according to claim 1, wherein the satellite observation data comprises a signal-to-noise ratio, pseudo-ranges at a plurality of epochs, and Doppler observation values at the plurality of epochs.

5. The method according to claim 4, further comprising:
differencing the pseudo-ranges at the plurality of epochs to determine pseudo-range detection values; and
deleting, from the pseudo-ranges at the plurality of epochs, a pseudo-range corresponding to a pseudo-range detection value in the pseudo-range detection values, in response to the pseudo-range detection value exceeding a first threshold value.

6. The method according to claim 4, further comprising:
differencing the Doppler observation values at the plurality of epochs to determine Doppler detection values; and
deleting, from the Doppler observation values at the plurality of epochs, a Doppler observation value corresponding to a Doppler detection value in the Doppler detection values, in response to the Doppler detection value exceeding a second threshold value. 7 The method according to claim 4, further comprising:
smoothing the Doppler observation values to obtain a pseudo-range reference value; and
correcting the pseudo-ranges according to the pseudo-range reference value.

8. The method according to claim 4, wherein the satellite observation data further comprises a carrier phase, and the method further comprises:
determining whether the carrier phase is abnormal or not by at least one selected from: an accumulated delta range state method, a Doppler cycle-slip detection method, an ionospheric residual method, or a higher-order difference method; and
deleting an abnormal carrier phase.

9. The method according to claim 4, wherein the state space representation comprises an orbit correction value and a clock offset correction value, the broadcast ephemeris data comprises orbit data and a clock offset, and performing the error correction on the broadcast ephemeris data using the state space representation comprises:
correcting the orbit data using the orbit correction value; and
correcting the clock offset using the clock offset correction value.

10. The method according to claim 9, wherein determining the target positioning model according to the satellite observation data and the corrected broadcast ephemeris data comprises:
in response to the satellite observation data corresponding to a plurality of frequency bands, performing an ionospheric-free combination operation on the satellite observation data corresponding to the plurality of frequency bands so as to obtain target satellite observation data; and
determining an original positioning model according to the corrected orbit data, the corrected clock offset, and the target satellite observation data,
wherein in a case that the satellite observation data does not comprise a carrier phase, the original positioning model comprises a pseudo-range point positioning model, and
wherein in a case that the satellite observation data comprises the carrier phase, the original positioning model comprises a precise point positioning model.

11. The method according to claim 9, wherein the state space representation further comprises an ionospheric spherical harmonic model, the broadcast ephemeris data further comprises an ionospheric delay, and performing the error correction on the broadcast ephemeris data using the state space representation comprises:
calculating an ionospheric delay reference value using the ionospheric spherical harmonic model; and
correcting the ionospheric delay using the ionospheric delay reference value.

12. The method according to claim 11, wherein determining the target positioning model according to the satellite observation data and the corrected broadcast ephemeris data comprises, in response to the satellite observation data corresponding to a single frequency band, determining the target positioning model according to the satellite observation data, the corrected orbit data, the corrected clock offset and the corrected ionospheric delay,
wherein in a case that the satellite observation data does not comprise a carrier phase, the original positioning model comprises a pseudo-range point positioning model, and
wherein in a case that the satellite observation data comprises the carrier phase, the original positioning model comprises a precise point positioning model.

13. The method according to claim 4, wherein performing the resolving operation on the target positioning model to obtain the position data of the target object comprises:
acquiring a parameter of the target positioning model at an initial epoch and a confidence level corresponding to the parameter;
determining a noise according to the signal-to-noise ratio and a stochastic model; and
performing a Kalman filtering operation according to the parameter at the initial epoch, the confidence level and the noise, so as to determine position data of the target object at a target epoch.

14. An electronic device, comprising:
at least one processor; and
a memory communicatively connected to the at least one processor, wherein the memory stores instructions executable by the at least one processor, and the instructions, when executed by the at least one processor, are configured to cause the at least one processor to at least:
acquire satellite observation data for a target object, broadcast ephemeris data for the target object, and state space representation for the target object;
perform an error correction on the broadcast ephemeris data using the state space representation;
determine a target positioning model according to the satellite observation data and the corrected broadcast ephemeris data; and
perform a resolving operation on the target positioning model to obtain position data of the target object.

15. The electronic device according to claim 14, wherein the instructions are further configured to cause the at least one processor to at least acquire the satellite observation data and the broadcast ephemeris data by calling a navigation satellite data acquisition interface of an operating system.

16. The electronic device according to claim 14, wherein the instructions are further configured to cause the at least one processor to at least acquire the state space representation through a connection with a server.

17. The electronic device according to claim 14, wherein the satellite observation data comprises a signal-to-noise ratio, pseudo-ranges at a plurality of epochs, and Doppler observation values at the plurality of epochs.

18. The electronic device according to claim 17, wherein the instructions are further configured to cause the at least one processor to at least:
difference the pseudo-ranges at the plurality of epochs to determine pseudo-range detection values; and
delete, from the pseudo-ranges at the plurality of epochs, a pseudo-range corresponding to a pseudo-range detection value in the pseudo-range detection values, in response to the pseudo-range detection value exceeding a first threshold value.

19. The electronic device according to claim 17, wherein the instructions are further configured to cause the at least one processor to at least:
difference the Doppler observation values at the plurality of epochs to determine Doppler detection values; and
delete, from the Doppler observation values at the plurality of epochs, a Doppler observation value corresponding to a Doppler detection value in the Doppler detection values, in response to the Doppler detection value exceeding a second threshold value.

20. A non-transitory computer-readable storage medium having computer instructions therein, wherein the computer instructions are configured to cause a computer system to at least:
acquire satellite observation data for a target object, broadcast ephemeris data for the target object, and state space representation for the target object;
perform an error correction on the broadcast ephemeris data using the state space representation;
determine a target positioning model according to the satellite observation data and the corrected broadcast ephemeris data; and
perform a resolving operation on the target positioning model to obtain position data of the target object.
